(19) United States
(12) Patent Application Publication
(10) Pub. No.: US 2002/0036733 A1
(43) Pub. Date: Mar. 28, 2002

(54) Reflection type liquid crystal display

(76) Inventors: Jang-Gun Park, Gyeonggi-do (KR); Jong-Dae Park, Seoul (KR); Dong-Pil Chang, Gyeonggi-do (KR); Jin-Baek Kim, Gyeonggi-do (KR)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/924,761

(22) Filed: Aug. 9, 2001

(30) Foreign Application Priority Data
Aug. 9, 2000 (KR) 2000-46117

(51) Int. Cl. G02F 1/1335

(52) U.S. Cl. 349/113

(57) ABSTRACT

There is disclosed an improved reflection type liquid crystal display. The reflection type LCD includes: a light source part for generating a light beam; and a light guiding part established at one side of the light source part, for guiding the light beam generated from the light source part uniformly; an LCD panel part disposed below the light guiding part, for forming an image. The reflection type LCD realizes uniform and high luminance even at a low power consumption. The light guiding part of the reflection type LCD has a pattern formed at one surface of the light guiding part and having a specific configuration and shape, thereby preventing the occurrence of the Moire fringes. In addition, The light guiding part allows the light beam generated from the light source to be uniformly incident onto the LCD panel part, thereby realizing reflection type LCDs having uniform and high luminance even at very low power consumption. The aforementioned advantages render the LCDs slimmer and lighter in weight and make the LCD to be used for small sized information displays like the portable information displays.

### BACKGROUND OF THE INVENTION

1. Field of the Invention

The present invention relates to a reflection type liquid crystal display, and more specifically to a reflection type liquid crystal display capable of showing high luminance even at lower power consumption, preventing occurrence of Moire fringes and obtaining a slimmer, lighter and smaller LCD.

2. Description of the Related Art

Generally, liquid crystal displays (LCDs) change alignment of liquid crystal molecules by applying an electric field to the liquid crystal molecules. Such LCDs utilize variations in optical properties such as birefringence of liquid crystal cell, circumpolarization, dichroism and light scattering, and so on, to change such variations in the optical properties into variations in visual properties. Thus, LCDs are flat panel displays using the light modulation.

LCDs are largely classified into twisted nematic (TN) type and super-twisted nematic (STN) type depending on the kinds of the liquid crystal as used and are classified into active matrix display type using TN liquid crystal and passive matrix display type using STN liquid crystal depending on the driving method.

A key difference between the active matrix display type and the passive matrix display type is the use of a transistor as switching element. Active matrix displays are thin film transistor (TFT)-LCDs using thin film transistors as switching element to drive, while passive matrix displays do not use thin film transistors as switching element and therefore it is not necessary to use a complicated circuit for driving the LCD.

Also, these LCDs are classified into a transparent type LCD using a back light and a reflection type using an external light source LCD depending on the types of the light sources used.

Currently, the transparent type LCDs using the back light are widely used, but the back light increases the power consumption as well as the volume and weight of the LCDs.

In order to resolve the aforementioned drawbacks of the transparent type LCDs, reflection type LCDs are gaining the popularity and many researches and developments are actively being performed.

Reflection type LCDs are especially anticipated to replace transparent type LCDs as consumer demands on the portable information displays increase.

Computer terminals using such reflection type LCDs of a TN type white-and-black or a STN type white-and-black, are now produced and color reflection type LCDs are also actively researched and developed.

Especially, the development of the color reflection type LCDs is one of the important subjects targeted in IMT-2000 (International Mobile Telecommunications-2000) and many researches for lighter, slimmer and down-sized structure are being performed, along with the colorization of the displays.

Japanese laid-open patent No. 1999-352470 discloses a general reflection type LCD and FIG. 1 shows a sectional view of such a reflection type LCD and a proceeding path of an incident light.

Referring to FIG. 1, a reflection type LCD comprises: an LCD panel 2, a reflective plate 4 disposed below the LCD panel 2, for reflecting toward the upper surface of the LCD panel an incident light beam which is incident onto the LCD panel 2; and a diffusion sheet 6 disposed on the LCD panel 2, and having a speckle pattern formed thereon.

When ambient light is incident onto the diffusion sheet 6 from the overall surface of the LCD panel 2, the diffusion sheet 6 having the speckle pattern scatters the incident light. The scattered light is incident onto the reflection plate 4 disposed at the rear surface of the LCD panel and is reflected by the reflection plate 4. The reflected light transmits the diffusion sheet 6 and is irradiated toward the outside of the LCD panel 2.

Since the above described reflection type LCD uses the ambient light as light source, it is not easy to secure a sufficient luminance. To this end, the reflection type LCD has a drawback of a low contrast ratio and indefiniteness of color tones and brightness.

To resolve these drawbacks, various endeavors such as alteration in the liquid crystal cell structure, finding of new material, and developments of reflective plate and optical filter are being tried and applied to the developments of DMGB (Double Metal Guest Host) LCD, ECB (Electrically Controlled Birefringence) LCD, PCGH (Phase-Change Guest-Host) LCD, NH(New Hysteresis) LCD, etc.

These various LCDs, however, have the same drawbacks in that the luminance of the incident light is low. To resolve these drawbacks, there is provided a way forming a lamp at one upper edge of these LCDs.

Upon applying this way, an amount of the incident light beams in the overall amount of the light beams generated from the lamp becomes smaller than that of the emitted light beams to the outside. As a result, pictures on the panel appear faint and high luminance can not be obtained. In addition, the way is not proper in miniaturizing the reflection type LCDs because of a volume occupied by the lamp.

Japanese patent application No. 7-011755 (related to U.S. Pat. No. 5,640,258) discloses a reflection type LCD using a light guiding plate and a cathode ray tube similar to a back light unit of recently developed transparent LCDs.

The aforementioned reflection type LCD consumes, however, power very much. Accordingly, it is not proper for appliances of portable information displays.

### SUMMARY OF THE INVENTION

Therefore, it is an object of the present invention to provide a reflection type LCD capable of obtaining high luminance with less power consumption, preventing the occurrence of the Moire fringes and obtaining a slimmer, lighter and smaller LCD.

To achieve the aforementioned object of the present invention, there is provided a reflection type liquid crystal display comprising: a light source part for generating a light beam; a light guiding part established at one side of the light source part, for uniformly guiding the light beam generated from the light source part; and an LCD panel part disposed below the light guiding part, for forming an image.

According to the present invention, the reflection type LCD comprises the light source part and the light guiding part for uniformly inducing toward the LCD panel part the light beams generated from the light source and thereby realizing reflection type LCDs having uniform and high luminance even with low power consumption.

Further, the light guiding part of the reflection type LCD has a pattern formed at one surface of the light guiding part and having a specific configuration and shape, thereby preventing the Moire fringes.

In addition, the reflection type LCD has the light guiding part for allowing the light beam generated from the light source to be uniformly incident onto the LCD panel part, thereby realizing reflection type LCDs having uniform and high luminance even with very low power consumption.

### BRIEF DESCRIPTION OF THE DRAWINGS

The above objects and other advantages of the present invention will become more apparent by describing in detail preferred embodiments with reference to the attached drawings in which:

FIG. 1 is a simplified sectional view of a conventional reflection type LCD showing a schematic path of incident light;

FIG. 2 is an exploded perspective view of the reflection type LCD in accordance with the present invention;

FIG. 3 is a plan view of the reflection type LCD in accordance with the present invention;

FIG. 4 is a sectional view taken along the line B1-B2 of FIG. 3;

FIG. 5 is a sectional view taken along the line D1-D2 of FIG. 4;

FIG. 6 is a schematic view describing an inclined configuration of a pattern of the light guiding part in the reflection type LCD in accordance with the present invention;

FIG. 7 is a schematic view describing an inclined configuration of a pattern of the light guiding part in the reflection type LCD in accordance with the present invention;

FIG. 8 is a graph showing computation results of the Moire fringes depending on angles between the pixel arrangement and the pattern arrangement of the light guiding part in the reflection type LCD in accordance with the present invention;

FIG. 9 is a sectional view taken along the line C1-C2 of FIG. 3;

FIG. 10 is a simplified sectional view showing a schematic proceeding path of an incident light within the light guiding part of the reflection type LCD in accordance with the present invention;

FIG. 11 is a graph showing measuring results of the reflectivity depending on the wavelengths in the reflection type LCD having a reflection preventive member in accordance with the present invention; and

FIG. 12 is a sectional view of the reflection type LCD showing a schematic proceeding path of an incident light in the reflection type LCD in accordance with the present invention.

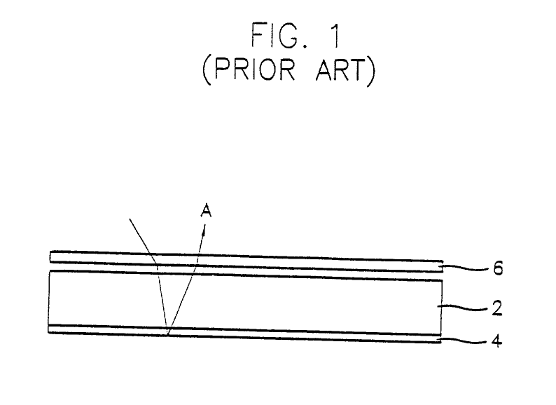

### DETAILED DESCRIPTION OF THE PREFERRED EMBODIMENTS

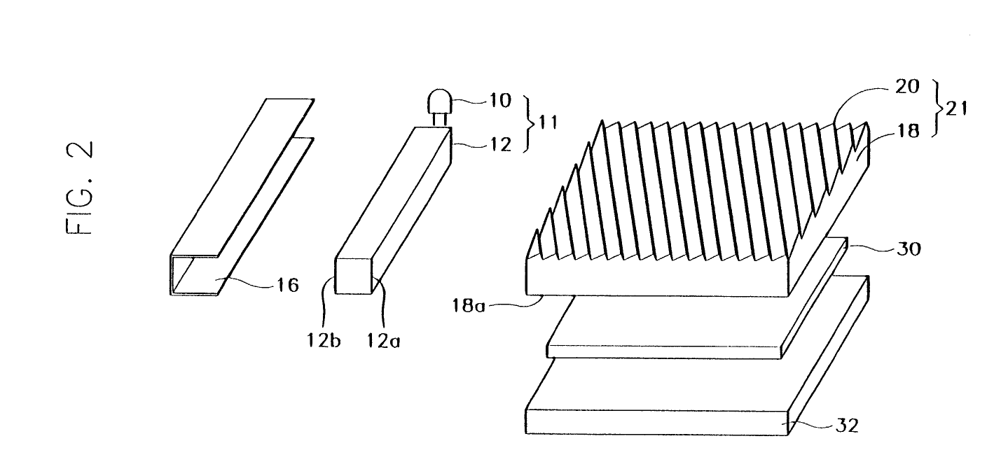

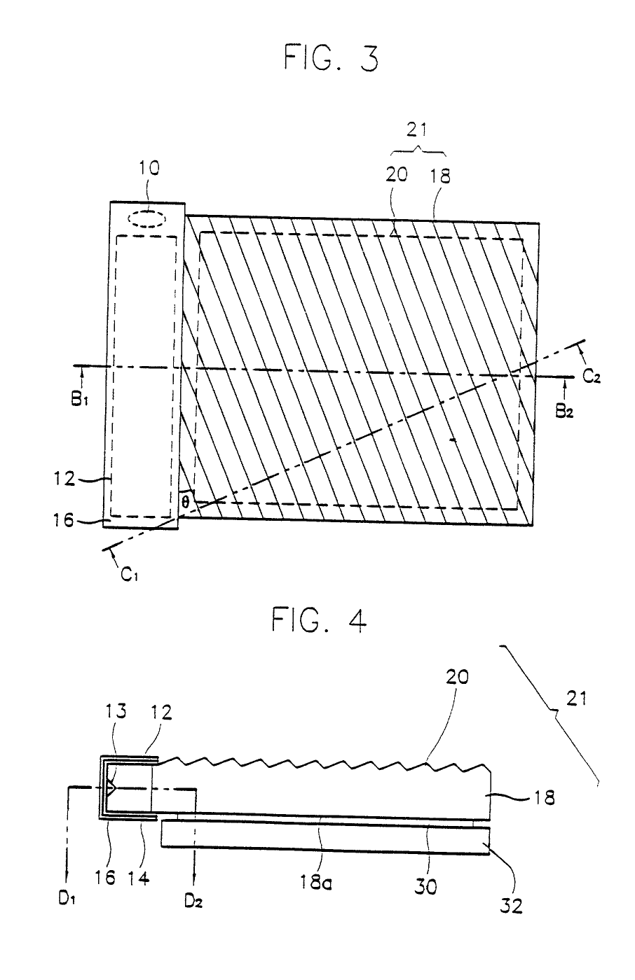

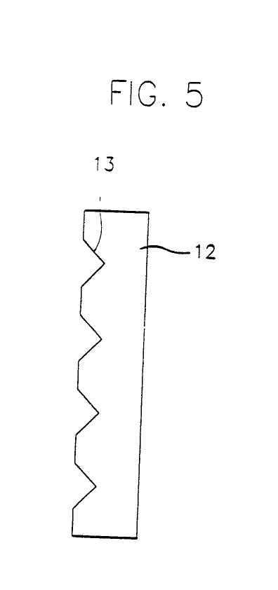

FIG. 2 is an exploded perspective view of a reflection type LCD in accordance with the present invention, FIG. 3 is a plan view of the reflection type LCD in accordance with the present invention, FIG. 4 is a sectional view taken along the line B1-B2 of FIG. 3, and FIG. 5 is a sectional view taken along the line D1-D2 of FIG. 4.

Referring to FIG. 2 and FIG. 3, a reflection type LCD of the present invention comprises a light source part 11, a light guiding part 21 arranged at one edge of the light source part 11, and an LCD panel part 32 arranged below the light guiding part 21 to form an image.

The light source part 11 is arranged at one edge of the light guiding part 21 and allows light beams generated from the light source part 11 to be incident onto the light guiding part 21.

The light guiding part 11 comprises a light source 10 including a light emitting device (LED). At one edge of the light source 10, a first light guiding plate 12 is provided to induce toward the light guiding part 21 the light beams generated from the light source 10.

The conventional reflection type LCD uses a linear light source such as cathode ray tubes (CRTs) which require a relatively high power consumption of approximately 1 Watt-7 Watts. On the other hand, the reflection type LCD having the above described constitution uses LEDs having a very low power consumption of about 70 mWatts compared with that of the conventional reflection type LCD. Despite the use of LEDs having the very low power consumption, the reflection type LCD of the present invention provides a very high luminance.

The first light guiding plate 12 has a plate shape of a rectangular parallelepiped structure and is made of transparent material such as polymethylmetacrylate (PMMA) pertaining to the plastic system. Preferably, the first light guiding plate 12 is composed of ARTON which is made by Japanese Synthetic Rubber company limited.

At this time, the first light guiding plate 12 can be made in a wedge shape.

Referring to FIG. 5, a first pattern part 13 is disposed at one surface 12b of the light guiding plate 12 that is opposite to the surface facing the light guiding plate 12 adjacent to the incident face of the light beams generated from the light source 10.

The first pattern part 13 functions to induce toward the light guiding part 21 light beams that are generated from the light source 10 and are then incident onto the first light guiding plate 12, and allow the induced light beams to be uniformly incident.

To perform the above described functions, the first pattern part 13 has a plurality of groove patterns of triangle shape. In the triangle shaped groove patterns, a vertex has preferably an angle of about 90 degrees.

Here, the first pattern part 13 may include various patterns such as dot patterns printed thereon.

Referring to FIG. 2 to FIG. 4, a housing 16 is disposed at outer surfaces of the light source part 11 and an edge portion of the light guiding part 21 adjacent to the light source part 11. The housing 16 is made of aluminum or brass and wraps the light source part 11 and a part of the light guiding part 21.

A reflection member 14 is disposed on inner surface of the housing 16. The reflection member 14 acts as reflecting toward the light guiding part 21 the light beams generated from the light source part 11.

The light guiding part 21 comprises a second light guiding plate 18.

The second light guiding plate 18 has a plate shape of a rectangular parallelepiped structure. The second light guiding plate 18 is arranged parallel to the first light guiding plate 12 and is of transparent material in the plastic system such as acryl comprising polymethylmetacrylate (PMMA). Preferably, the second light guiding plate 18 is made of ARTON which is a product of the Japanese Synthetic Rubber company limited.

At this time, the second light guiding plate 18 has preferably a wedge shape.

Also, between the light guiding part 21 and the light source part 11, there is further provided a diffusion plate (not shown) for the uniform distribution of the incident light beams from the light source part 11 to the light guiding part 21.

In the light, the second light guiding plate 18 has to sufficiently transmit light beams generated from an external light source toward the LCD panel. In the dark, the second light guiding plate 18 reflects toward the LCD panel part 32 the light beams generated from the light source placed at the side of the light guiding part 21 in the dark and transmits the light beams reflected from the LCD panel part 32 to the outside, thereby displaying a picture on the panel 32. In other words, the second light guiding plate 18 uses reflection and transmittance characteristics due to the difference in the refractive index to thereby control the light path depending on the pattern shape of the second light guiding plate 18.

To reflect the light beams toward the LCD panel part 32 and transmit the light beams reflected from the LCD panel part 32, there is provided a second pattern part 20 at the upper surface of the second light guiding plate 18, which is opposite to the surface facing the upper surface of the LCD panel 32.

When an incident light is reflected by the second pattern part 20 and is then incident onto the LCD panel part 32, the interference between pixels of the LCD panel part 32 and the incident light beams to the LCD panel part 32 causes Moire fringes showing wave patterns on the screen. To prevent the Moire fringes, the second pattern part 20 has a plurality of patterns inclined at a constant interval by an angle of θ with respect to a flat surface of the second light guiding plate 18.

In more detail, the Moire fringes occur depending on the shape of the second pattern part 20 and the structure of the LCD panel 30. In other words, the Moire fringes occur by the complicated interaction of the reflective face of the second pattern part 20 and the reflective face of the LCD panel.

Hereinafter, the Moire fringes are described with reference to the accompanying drawings.

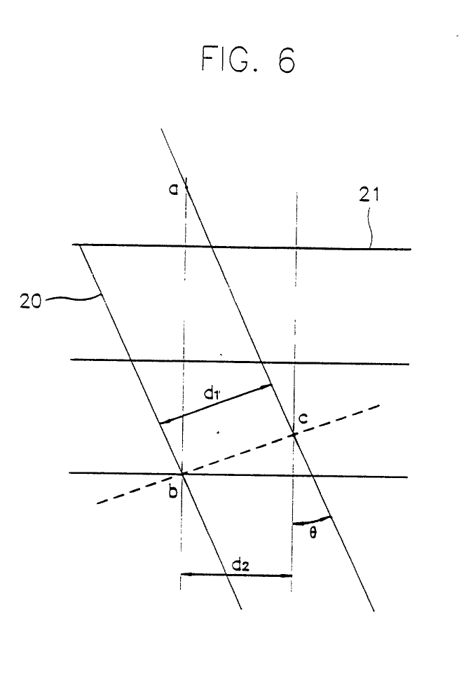

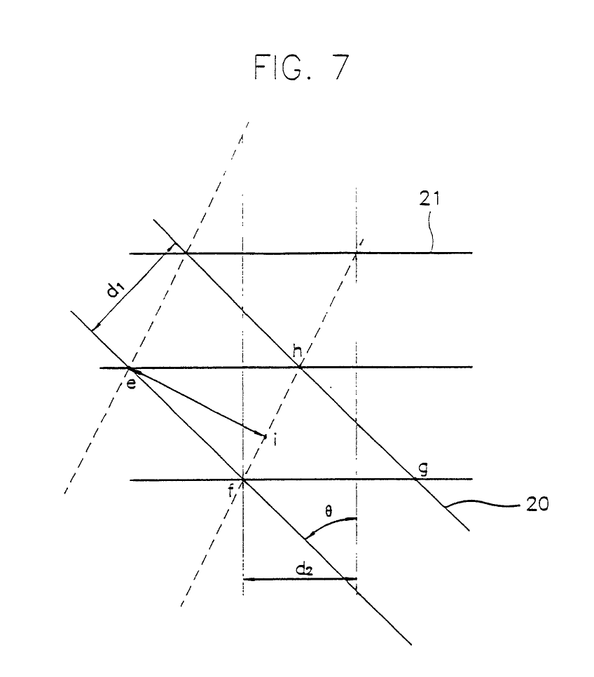

FIG. 6 and FIG. 7 are schematic views describing an inclined configuration of a pattern of the second light guiding plate 18 in the reflection type LCD in accordance with the present invention.

Referring to FIG. 6 and FIG. 7, the second pattern part 20 is formed on the upper surface of the second light guiding plate 18 and is arranged at an angle of θ with respect to the pixel pattern 21 of the LCD panel 32.

In FIG. 6, a distance “d1” between the patterns of the second pattern part 20 is larger than a distance “d2” between the pixels of the LCD panel and the inclination angle θ is between zero and more and 45 degrees and less. In FIG. 7, a distance “d1” between the patterns of the second pattern part 20 is larger than the distance “d2” and the inclination angle θ is between 45 degrees and more and 90 degrees and less.

In the example of FIG. 6, the interval (ac) of the Moire fringes is defined as the following equation (1).

$$ac = \frac{{d}_{1}}{tan θ} \qquad Eq . ( 1 )$$

In the example of FIG. 7, the interval (ei) of the Moire fringes is defined as the following equation (2).

$$e i = \frac{{d}_{1} ( 1 + α )}{\sqrt{{( 1 + α - sin θ )}^{2} + {cos}^{2} θ}} ( - 1 \leq α \leq 0 ) \qquad Eq . ( 2 )$$

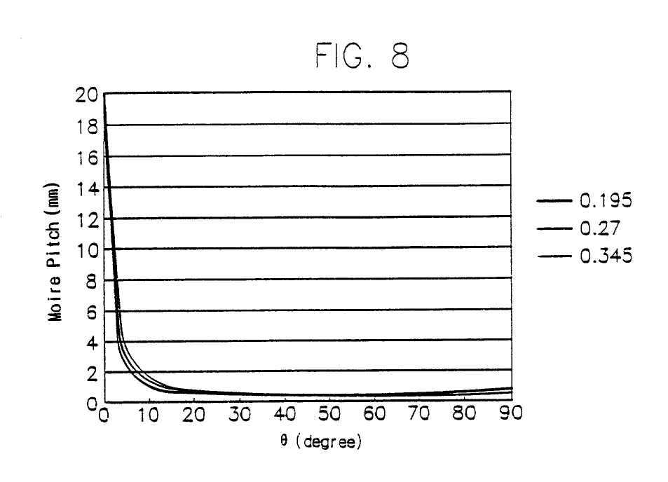

FIG. 8 shows computation results of the Moire fringes obtained from the above equations (1) and (2), in which a reflection type LCD as used is 2.04″ in the diagonal size, 153 μm in the interval “d2” between pixels, 0.195 mm, 0.27 mm, and 0.345 mm in the distance “d1” between the patterns of the second pattern part 20.

Referring to FIG. 8, it appears that the intervals of the Moire fringes sensitively vary with the inclination angle in the angle range of 0<θ<15 degrees. When an interval of the Moire fringes of when a user's eye bears ill feeling toward the Moire fringes is 2 mm and more, and the distance “d1” between the patterns of the second pattern part 20 is 0.195 mm, the inclination angel of θ should be greater than 5.5 degrees to remove the visible Moire fringes. At this time, when the inclination angle of θ is smaller than 5.5 degrees, the Moire fringes are distinctively shown on the panel.

Thus, by increasing the inclination angle of θ, the interval between the Moire fringes becomes smaller and thereby a picture having a good quality appears on the panel. And, upon increasing the distance between the patterns, the intervals between the Moire fringes tend to rise accordingly. In addition, when the inclination angle of θ is 20 degrees and more, the occurrence of the Moire fringes can be prevented regardless of the interval between the patterns of the second pattern part 20.

Meanwhile, when the inclination angle of θ is 20 degrees and less, there occurs a problem in that the light beams are concentrated at the center of the second light guiding plate 18 and when the inclination angle θ is 30 degrees and more, the uniformity of the light beams incident from the side of the second light guiding plate 18 is lowered and a uniform luminance can not be obtained.

Therefore, it is desirous that the inclination angle θ is in the range of 20 degrees to 30 degrees, most preferably about 22.5 degrees.

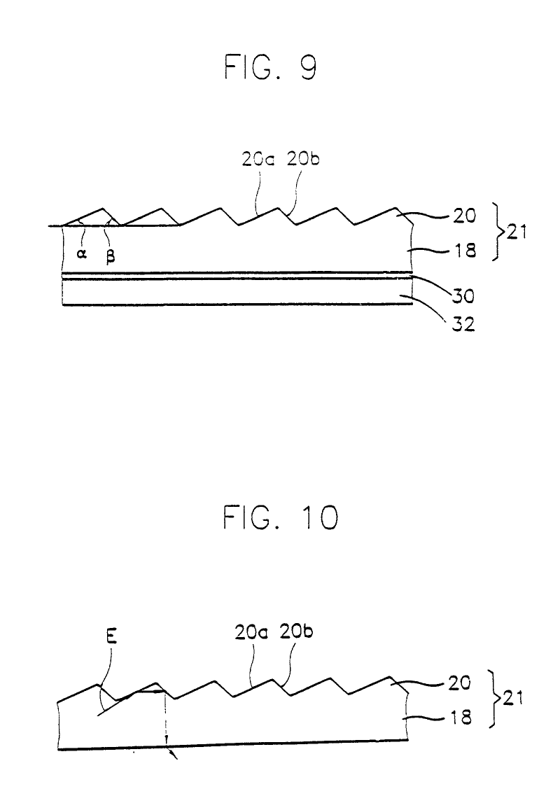

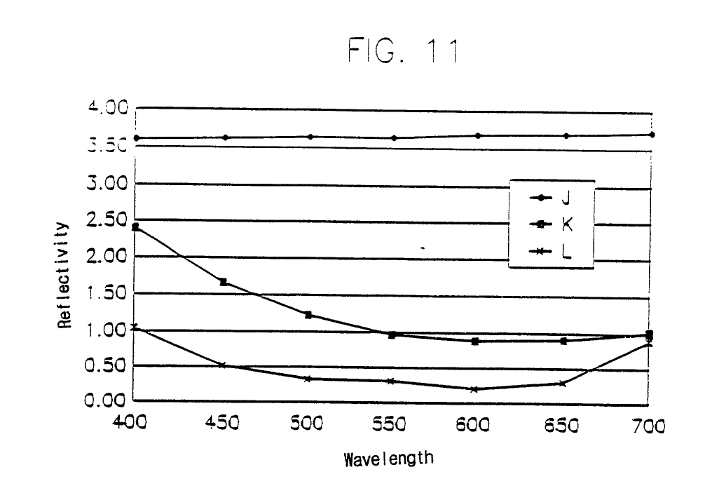

FIG. 9 is a sectional view taken along the line C1-C2 of FIG. 3 and FIG. 10 is a simplified sectional view showing a schematic proceeding path of an incident light within the light guiding part 21 of the reflection type LCD in accordance with the present invention.

Referring to FIG. 9 and FIG. 10, the second pattern part 20 comprises: a reflective face 20b for reflecting toward the LCD panel part 32 a part of the light beams incident from the second light guiding plate 18; and a transparent face 20a for transmitting the light beams which are reflected from the LCD panel part 32 and then are again incident onto the second light guiding plate 18.

Preferably, the second pattern part 20 has a configuration in which a plurality of patterns having a prism shape whose sectional face is triangle are arranged in parallel on the upper surface of the second light guiding plate 18.

In the aforementioned patterns of the second pattern part 20, the transparent face 20a is one adjacent to the first light guiding plate 12 and the reflective face 20b is one corresponding to the transparent face 20a and facing with one side surface of the first light guiding plate 12.

Referring to FIG. 10, an acute angle between the reflective face 20b and the flat surface of the second light guiding plate 18 is preferably in the range of 24 degrees to 45 degrees such that the second pattern part 20 reflects a part of the light beams which are incident from the first light guiding plate 12.

When the acute angle is smaller than 24 degrees or larger than 45 degrees, there occurs a problem in that the light beams output from the first light guiding plate 12 are not directed toward the lower surface of the second light guiding plate 18, that is, toward the LCD panel part 32.

More preferably, the acute angle between the reflective face 20b and the flat surface of the second light guiding plate 18 is in the range of 33 degrees to 34 degrees.

Also, an acute angle “α” between the transparent face 20a and the second light guiding plate 18 is preferably in the range of 3.0 degrees to 3.5 degrees.

When the acute angle α exceeds such range, the light beams incident onto the LCD panel part 32 through the second pattern part 20 and then are reflected by the LCD panel part 32 can not transmit the second light guiding plate 18.

At the lower surface of the light guiding part 21, that is, between the light guiding part 21 and the LCD panel part 32, there is provided an anti-reflective member 30 to prevent the light beams reflected from the second pattern part 20 of the second light guiding plate 18 and are then incident onto the LCD panel part 32, from being again reflected at a boundary face where the second light guiding plate 18 is in contact with the LCD panel part 32.

The anti-reflective member 30 can be formed at any one place of the overall surface of the lower face of the second light guiding plate 18 and a selected portion of the second light guiding plate 18 corresponding to the pixel forming region of the LCD panel part 32.

The anti-reflective member 30 comprises a glue layer, a first zirconium dioxide (ZrO₂) layer, a first silicon oxide layer, a second zirconium dioxide (ZrO₂) layer and a second silicon oxide layer and they are stacked on the rear surface of the second light guiding plate 18 in the named order.

Preferably, the anti-reflective member 30 is formed by stacking a second silicon oxide layer, the second zirconium dioxide layer (ZrO₂) layer, the first silicon oxide layer, the first zirconium dioxide (ZrO₂) layer, and the glue layer on a selected surface of the second light guiding plate 18 adjacent to the LCD panel part 32 using a sputtering method in the named order.

The anti-reflective member 30 can be formed in five layers and more. When the anti-reflective member 30 is formed by five layers and more, despite of minimal errors generated in controlling the thickness of the stacked layers, the transmissivity of the light beams is maximized to 95% and more, to thereby enhance the whole luminance of the LCD.

FIG. 11 shows a measuring result of the reflectivity in the reflection type LCD to which the aforementioned anti-reflective member 30 is applied.

In FIG. 11, reference numeral “J” corresponds to a measuring result (hereinafter referred to as “case J”) of the reflectivity in a reflection type LCD to which the anti-reflective member 30 is not applied, reference numeral K corresponds to a measuring result(hereinafter referred to as “case K”) of the reflectivity in a reflection type LCD to which an anti-reflective member 30 having a three layer-stacked configuration is applied, and reference numeral L corresponds to a measuring result(hereinafter referred to as “case L”) of the reflectivity in a reflection type LCD to which an anti-reflection member 30 having a five layer-stacked configuration is applied.

Referring to FIG. 11, the case L is much lower in the reflectivity than the case J and the case K over the whole wavelength range as measured.

Returning to FIG. 9, the LCD panel part 32 is disposed below the light guiding part 21. The LCD panel part 32 includes a reflection type LCD panel.

The light guiding part 21 can be attached to the LCD panel part 32 using a glue member (not shown).

In case that the anti-reflective member 30 is formed on the overall surface of the lower face of the second light guiding plate 18, the glue member is formed at an outer side surface of the anti-reflective member 30. And, in case that the anti-reflective member 30 is formed only at a corresponding portion of the pixel forming region within the LCD panel 32, the glue member can be formed at an outer side portion of the lower face of the second light guiding plate 18.

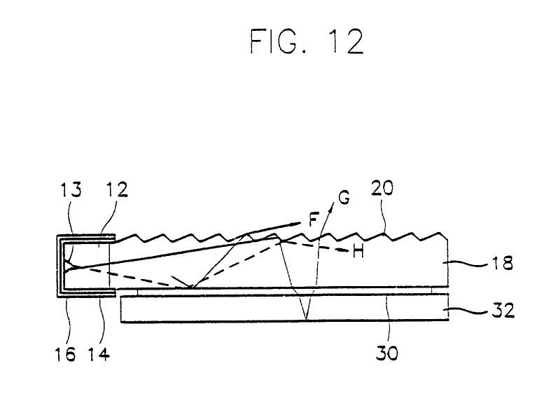

FIG. 12 shows a proceeding path of the incident light beams in the reflection type LCD in accordance with the present invention.

Referring to FIG. 12, light beams generated from a light source are incident onto the first light guiding plate 12, are reflected from the first pattern part 13 of the first light guiding plate 12 and the reflection member 14 disposed at the outer surface of the first light guiding plate 12, and are incident into the second light guiding plate 18.

Thereafter, the light beams are incident within the second light guiding plate 18 at various angles and then the incident light beams are divided depending on their proceeding paths into a leakage light “F” which is reflected from the lower surface of the second light guiding plate 18 and is then transmitted over the second light guiding plate 18 through the second pattern part 20, a reflection light “G” which is reflected toward the LCD panel 32 by the reflection face of the second pattern part 20, and a refractive light “H” which is refracted inside the second light guiding plate 18.

In the above, the leakage light “F” lowers the contrast. To minimize such a leakage light, the anti-reflective member 30 is disposed on the lower surface of the second light guiding plate 18. Thus, the anti-reflective member 30 prevents the leakage of light beams reflected from the lower surface of the second light guiding plate 18.

The refracted light “H” is repeatedly reflected inside the second light guiding plate 18 and thereafter is incident toward the LCD panel 30.

Through the aforementioned mechanism, the reflection type LCD of the present invention can secure the incident light to a maximum degree and thereby enhancing the luminance of the LCD.

As previously described, the reflection type LCD of the present invention is provided with a light source part having very low power consumption and a light guiding part for uniformly inducing the light beams generated from the light source toward the LCD panel, thereby realizing reflection type LCDs with a low power consumption and a high luminance.

Also, the reflection type LCD is provided with a light guiding part including patterns with a specific configuration, thereby realizing a reflection type LCD capable of preventing the Moire fringes on the LCD panel and having a high luminance.

Accordingly, the overall thickness and weight of the reflection type LCD are minimized and uniform and high luminance is obtained. Thus, the aforementioned advantages render the LCDs slimmer and lighter in weight and allow the LCD to be used for small sized information displays like the portable information displays.

While the present invention has been described in detail, it should be understood that various changes, substitutions and alterations can be made hereto without departing from the spirit and scope of the invention as defined by the appended claims.

What is claimed is:

1. A reflection type liquid crystal display, comprising:
a light source part for generating a light beam;
a light guiding part established at one side of the light source part, for guiding the light beam generated from the light source part uniformly; and
an LCD panel part disposed below the light guiding part, for forming an image.

2. The reflection type liquid crystal display of claim 1, wherein said light part source comprises:
a light source for generating a light beam; and
a first light guiding plate disposed at one side of the light source, for inducing the light beam generated from the light source toward the light guiding part.

3. The reflection type liquid crystal display of claim 2, wherein the light source comprises an LED.

4. The reflection type liquid crystal display of claim 2, wherein the first light guiding plate further comprises a first pattern part for allowing the light beam generated from the light source to be uniformly incident onto the light guiding part.

5. The reflection type liquid crystal display of claim 4, wherein the first pattern part is formed at a corresponding face of the first light guiding plate corresponding to an adjacent face of the first light source plate adjacent to the light guiding part.

6. The reflection type liquid crystal display of claim 4, wherein the first pattern part comprises a plurality of groove patterns.

7. The reflection type liquid crystal display of claim 6, wherein the groove pattern is a triangle in its sectional shape.

8. The reflection type liquid crystal display of claim 7, wherein the groove pattern comprises a vertex whose acute angle is approximately 90 degrees.

9. The reflection type liquid crystal display of claim 1, wherein the light guiding part comprises a second light guiding plate for inducing the light beam generated from the light source part toward the LCD panel part.

10. The reflection type liquid crystal display of claim 9, wherein the light guiding part comprises a second pattern part that reflects a part of the light beam input from the light source part toward the LCD panel and transmits a part of the light beam reflected from the LCD panel.

11. The reflection type liquid crystal display of claim 10, wherein the second pattern part is formed at a selected portion of the second light guiding plate which is opposite to a face of the second light guiding plate adjacent to the LCD panel part.

12. The reflection type liquid crystal display of claim 10, wherein the second pattern part comprises a pattern that is inclined by an angle of 20 degrees to 30 degrees along the light guiding part direction with respect to an axis of a contact face between the light source part and the light guiding part.

13. The reflection type liquid crystal display of claim 10, wherein the second pattern part comprises a plurality of prism-shaped patterns arranged in parallel along a selected direction, each of the plurality of the prism-shaped patterns having a transparent face disposed adjacent to the light source part, for transmitting the light beams which are reflected from the LCD panel part and a reflective face corresponding to the transparent face, for reflecting toward the LCD panel part the light beams which are incident from the light source part.

14. The reflection type liquid crystal display of claim 13, wherein the pattern of the second pattern part has a first acute angle formed by the transparent face of the pattern and a flat surface of the light guiding part in the range of 3.0 degrees to 3.5 degrees and a second acute angle formed by the reflective face of the second pattern and the flat surface of the light guiding part in the range of 33 degrees to 34 degrees.

15. The reflection type liquid crystal display of claim 1, further comprising a housing wrapping a part of the light source part and the light guiding part.

16. The reflection type liquid crystal display of claim 15, wherein the housing comprises a reflector formed at an inner surface of the housing, for reflecting toward the light guiding part the light beams generated from the light source.

17. The reflection type liquid crystal display of claim 15, wherein the housing is made of any one selected from a group consisting of aluminum and brass.

18. The reflection type liquid crystal display of claim 1, further comprising a diffusion means disposed between the light source part and the light guiding part, for allowing to have a uniform distribution light beams generated from the light source and incident onto the light guiding part.

19. The reflection type liquid crystal display of claim 1, further comprising an anti-reflective means disposed between the light guiding part and the LCD panel part, for preventing light beams induced from the light guiding part to the LCD panel part from being reflected by a contact face between the light guiding part and the LCD panel part.

20. The reflection type liquid crystal display of claim 19, wherein the anti-reflective means comprises:
a glue layer;
a first zirconium dioxide (ZrO₂) layer;
a first silicon oxide layer;
a second zirconium dioxide (ZrO₂) layer; and
a second silicon oxide layer.

21 The reflection type liquid crystal display of claim 20, wherein the anti-reflective means is formed at a face of the light guiding part adjacent to the light LCD panel part by depositing the second silicon oxide layer, the second zirconium dioxide layer, the first silicon oxide layer, the first zirconium dioxide layer, and the glue layer in the named order using a sputtering method.
